(19) United States
(12) Patent Application Publication
(10) Pub. No.: US 2006/0063463 A1
(43) Pub. Date: Mar. 23, 2006

(54) Method of manufacturing flat lamp

(75) Inventors: Gi-young Kim, Gyeonggi-do (KR); Hyoung-bin Park, Gyeonggi-do (KR); Seong-eui Lee, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG CORNING CO., LTD., Gyeonggi-do (KR)

(21) Appl. No.: 11/141,051

(22) Filed: Jun. 1, 2005

(30) Foreign Application Priority Data
Sep. 23, 2004 (KR) 10-2004-0076346

(51) Int. Cl. H01J 9/00; H01J 9/20; B05D 5/06

(52) U.S. Cl. 445/26; 445/27; 445/22; 427/67

(57) ABSTRACT

Provided is a method of manufacturing a flat lamp. An embodiment of the method includes attaching at least a spacer on a lower substrate, coating a first sealing paste on an upper rim portion of the lower substrate and attaching a frame for sealing a discharge space on the first sealing paste, coating a phosphor on an upper surface of the lower substrate, surfaces of the spacers, and an inner wall of the frame, and firing the first sealing paste and the phosphor at a predetermined temperature.

### BACKGROUND

This application claims the priority of Korean Patent Application No. 10-2004-0076346, filed on Sep. 23, 2004, in the Korean Intellectual Property Office, the disclosure of which is incorporated herein in its entirety by reference.

1. Field of the Invention

The present invention relates to a method of manufacturing a flat lamp using a simple process.

2. Description of the Related Art

Flat lamps have developed as back-lights of liquid crystal displays (LCD) have improved to a surface discharge type or a facing discharge type flat lamp, in which a whole lower portion of the light emitting surface is a discharge space, in consideration of luminous efficiency and uniformity of brightness from a conventional edge-light type or a direct-light type flat lamp which uses a cold cathode fluorescent lamp. The surface discharge type flat lamp has an advantage of a stable discharge characteristic compared to a facing discharge flat lamp, but brightness is inferior to the facing discharge flat lamp.

FIG. 1 is an exploded perspective view of a conventional surface discharge flat lamp. FIG. 2 is a partial cross-sectional view of the flat lamp of FIG. 1.

Referring to FIGS. 1 and 2, a flat lamp includes an upper panel 80 and a lower panel 70 that form a sealed discharge space by coupling to each other. The discharge space is filled with a gas mixture of neon (Ne) gas and xenon (Xe) gas. The upper panel 80 includes an upper substrate 20, first and second upper electrodes 22a and 22b formed in pairs on an upper surface of the upper substrate 20, a phosphor layer 30 formed on a lower surface of the upper substrate 20. Here, the first upper electrodes 22a are connected to a first upper common line 23, and the second upper electrodes 22b are connected to a second upper common line 24.

The lower panel 70 includes a lower substrate 10 disposed at a predetermined distance from the upper substrate 20, first and second lower electrodes 12a and 12b formed in pairs on a lower surface of the lower substrate 10, frames 16 that seals the discharge space by disposing on the lower substrate 10, spacers 14 that form a plurality of discharge cells 15 by defining the discharge space and disposed on a lower substrate 10, and a phosphor layer 30 formed on inner wall of the discharge cells 15. Here, the first lower electrodes 12a are connected to a first lower common line (not shown), and the second lower electrodes 12b are connected to a second lower common line (not shown). The spacers 14 not only support the lower substrate 10 and the upper substrate 20 but also prevent crosstalk between the adjacent discharge cells 15. The phosphor layer 30 is formed on an upper surface of the lower substrate 10, surfaces of the spacers 14, and on an inner wall of the frames 16.

In the above configuration, no discharge occurs between the first lower electrode 12a and the first upper electrode 22a since the same potential is applied to the first lower electrode 12a and the first upper electrode 22a. Also, no discharge occurs between the second lower electrode 12b and the second upper electrode 22b since the same potential is applied to the second lower electrode 12b and the second upper electrode 22b. On the other hand, surface discharges occur in a parallel direction to the lower substrate 10 and the upper substrate 20 since a predetermined potential is present between the first lower electrode 12a and the first upper electrode 22a and between the second lower electrode 12b and the second upper electrode 22b, respectively.

A method of manufacturing a flat lamp depicted in FIGS. 1 and 2 is depicted in FIGS. 3A through 3E. Referring to FIG. 3A, the spacers 14 are formed on an upper surface of the lower substrate 10 on which the first and second lower electrodes 12a and 12b are formed. Here, the spacers 14 can be formed on an upper surface of a dielectric layer (not shown) formed on the lower substrate 10. Next, as depicted in FIG. 3B, a phosphor layer 30 is formed on an upper surface of the lower substrate 10 except rim portion and on a surface of the spacers 14. The phosphor layer 30 can be formed by coating a phosphor on the upper surface of the lower substrate 10 and the surface of the spacers 14 and firing the phosphor at a temperature range of approximately 450-490° C. And, referring to FIG. 3C, the frames 16 are attached to a supporter 50 using a tape and a phosphor layer 30 is formed on surfaces of the frames. The phosphor layer 30 can be formed by coating a phosphor on surfaces of the frames 16 and firing the phosphor at a temperature range of approximately 450-490° C. The phosphor layer 30 formed on a portion of the surface of the frames 16 that does not contact with the discharge space is removed after the firing process. Next, as depicted in FIG. 3D, a frit paste 41 for sealing the discharge space by attaching the frames 16 is coated on an upper rim portion of the lower substrate 10. The frames 16, on which the phosphor layer 30 is formed, are separated from the supporter 50 and pressed down on the lower substrate 10 on which the frit paste 41 is coated. The resultant product is fired at a temperature of approximately 420-450° C. Then, a lower panel 70 as depicted in FIG. 3E is completed. A flat lamp is manufactured by coupling the manufactured lower panel 70 with an upper panel 80.

As described above, according to a conventional method of manufacturing a flat lamp, an additional process for forming a phosphor layer 30 on the frame 16 is required and there is a problem that the phosphor layer 30 formed on the frame is easily peeled off in a subsequent process. Also, there is a risk of leaking the discharge gas when the phosphor contacts on the frit paste which can cause an incomplete packaging the discharge space.

### SUMMARY

The present invention provides a method of manufacturing a flat lamp with a simple process.

According to an aspect of the present invention, there is provided a method of manufacturing a flat lamp comprising attaching at least a spacer on a lower substrate, coating a first sealing paste on an upper rim portion of the lower substrate and attaching a frame for sealing a discharge space on the first sealing paste, coating a phosphor on an upper surface of the lower substrate, surfaces of the spacers, and an inner wall of the frame, and firing the first sealing paste and the phosphor at a predetermined temperature.

The first sealing paste and the phosphor can be fired at a temperature of about 450 to about 490° C., preferably, at about 480° C. The first sealing paste is a frit paste and the frit paste is a plastic based paste.

The attaching the spacers can include forming a dielectric layer on an upper surface of the lower substrate and attaching the spacers on the dielectric layer.

The method can further comprise forming at least a lower electrode on the lower substrate.

The lower electrodes may be formed on a lower surface of the lower substrate before attaching the spacers on the lower substrate.

The lower electrodes can be formed by forming an electrode material in a predetermined shape on a lower surface of the lower substrate and firing the electrode material at a temperature of about 530 to about 590° C.

The method can further comprise forming a phosphor layer on a lower surface of the upper substrate, and coupling the upper substrate on which the phosphor layer may be formed to an upper surface of the frames.

The coupling the upper substrate can include coating a second sealing paste on an upper surface of the frame and attaching the upper substrate on which the phosphor layer may be formed on the second sealing paste and firing the second sealing paste at a predetermined temperature.

The second sealing paste is fired at a temperature of about 420 to about 450° C., preferably, at about 440° C.

The second sealing paste may be a frit paste and the frit paste may be a terpineol based paste The phosphor layer can be formed by coating a phosphor on a lower surface of the upper substrate and firing the phosphor at a predetermined temperature. Here, the phosphor may be fired at a temperature of about 450 to about 490° C., preferably, at about 480° C.

The method can further comprise forming at least one upper electrode on the upper substrate.

The upper electrodes may be formed on an upper surface of the upper substrate before forming the phosphor layer on a lower surface of the upper substrate.

The upper electrodes can be formed by forming an electrode material in a predetermined shape on a lower surface of the upper substrate and firing the electrode material at a temperature of about 530 to about 590° C.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a conventional surface discharge flat lamp;

FIG. 2 is a partial cross-sectional view of the flat lamp of FIG. 1;

FIGS. 3A through 3E are drawings for describing a method of manufacturing a conventional flat lamp; and

FIGS. 4A through 4F are drawings for describing a method of manufacturing a flat lamp according to an embodiment of the present invention.

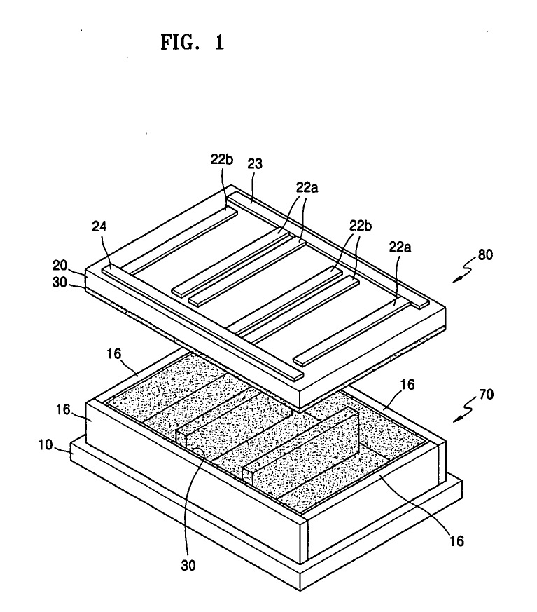

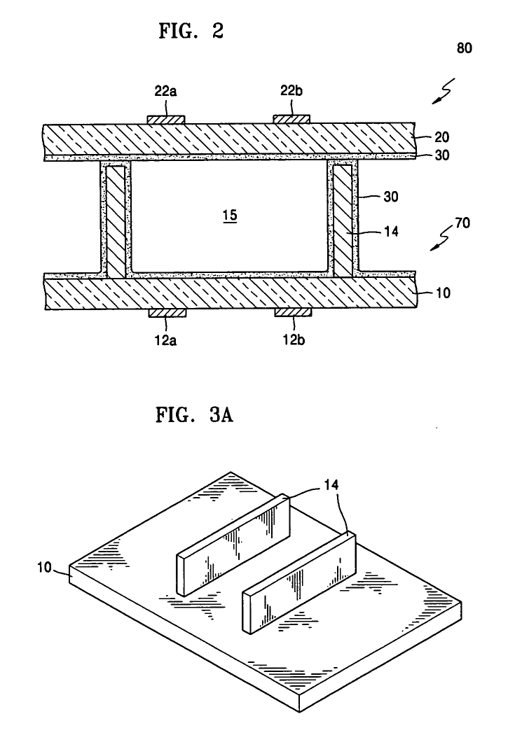

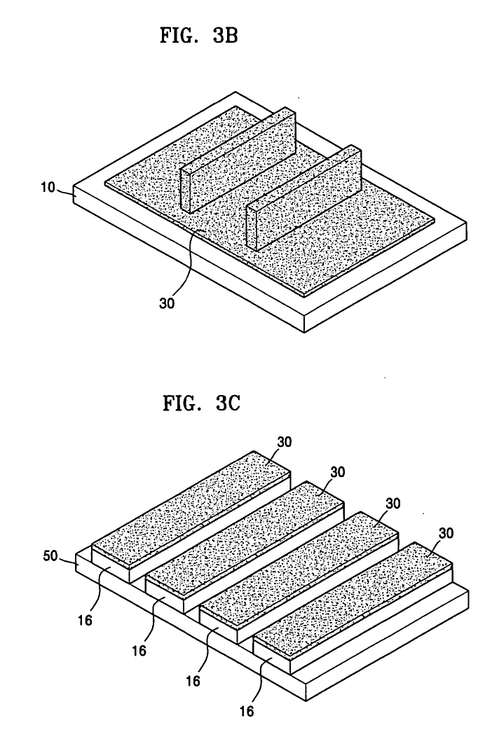

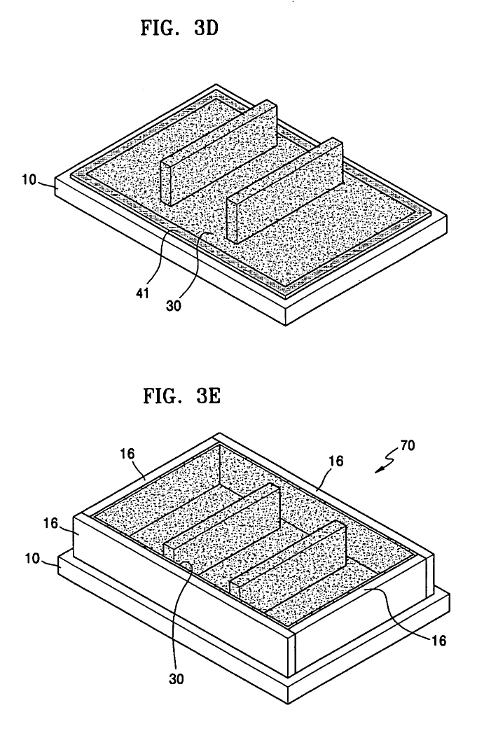

### DETAILED DESCRIPTION OF EXEMPLARY EMBODIMENTS OF THE INVENTION

Embodiments of the present invention will now be described more fully with reference to the accompanying drawings in which embodiments of the present invention are shown. Like reference numerals refer to the like elements throughout the drawings.

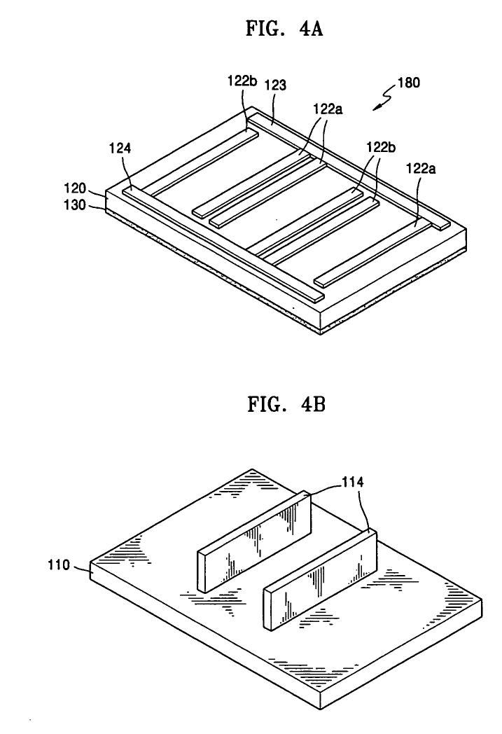

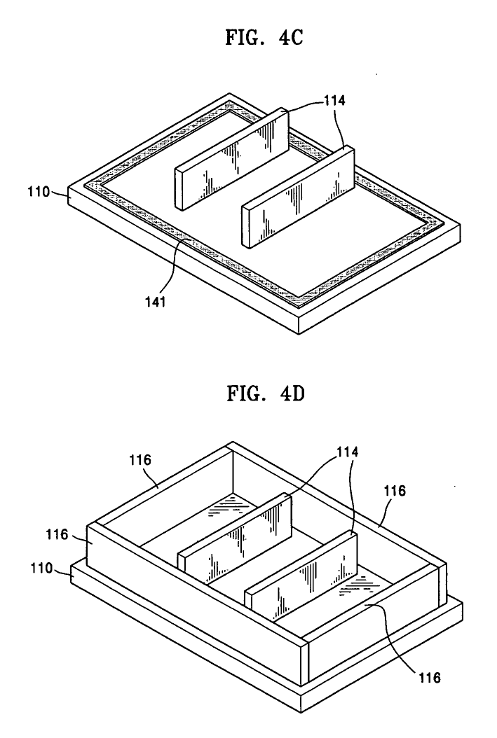

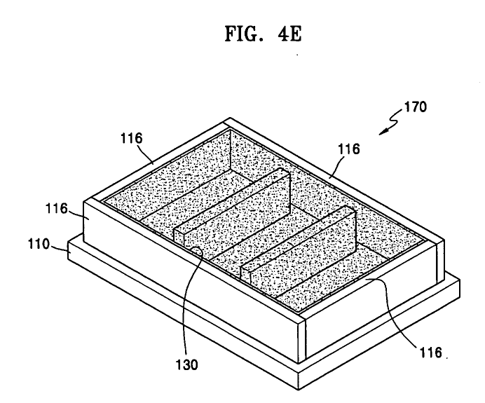

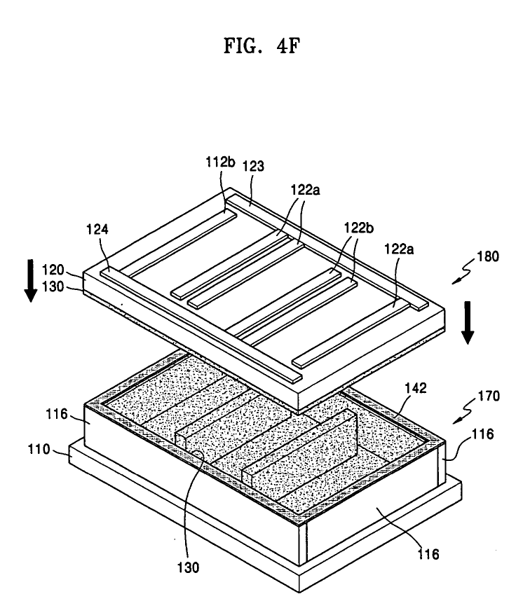

FIGS. 4A through 4F are drawings for describing a method of manufacturing a flat lamp according to an embodiment of the present invention.

Referring to FIG. 4A, first, an upper panel 180 may be manufactured. The upper panel 180 may be manufactured by forming at least one first upper electrode 122a and one second upper electrode 122b on an upper surface of an upper substrate 120 and forming a phosphor layer 130 on a lower surface of the upper substrate 120. The upper substrate 120 can be formed of a transparent glass substrate.

The first and second upper electrodes 122a and 122b can be formed by forming an electrode material in a predetermined shape on a lower surface of the lower substrate 120 using a screen printing method or a lithography process and firing the electrode material at a temperature of about 530 to about 590° C. Here, the first and second upper electrodes 122a and 122b can be formed of a transparent conductive material, such as ITO, or a metal. A first upper common line 123 to which the first upper electrodes 122a are connected and a second upper common line 124 to which the second upper electrodes 122b are connected can be formed on an upper surface of the upper substrate 120.

The phosphor layer 130 can be formed by coating a phosphor on a lower surface of the upper substrate 120 and firing the phosphor at a predetermined temperature. Here, the phosphor layer 130 can be fired at a temperature of approximately about 450 to about 490° C. and, preferably, at a temperature of about 480° C.

Next, referring to FIG. 4B, a lower substrate 110 is prepared to manufacture a lower panel. At least one first lower electrode (not shown) and one second lower electrode (not shown) are formed on a lower surface of the lower substrate 110 and at least a spacer 114 is attached to an upper surface of the lower substrate 110. The lower substrate 110 can be formed of a transparent glass substrate as the upper substrate 120.

The first and second lower electrodes can be formed by forming an electrode material in a predetermined shape on a lower surface of the lower substrate 110 using a screen printing method or a lithography process and firing the electrode material at a temperature of about 530 to about 590° C. Here, the first and second lower electrodes can be formed of a transparent conductive material, such as ITO, or a metal. A first lower common line (not shown) to which the first lower electrodes are connected and a second lower common line to which the second lower electrodes are connected can be formed on a lower surface of the lower substrate 110.

The spacers 114 can support the lower substrate 110 and the upper substrate 120 and can form a plurality of discharge cells by defining the discharge space formed between the lower substrate 110 and the upper substrate 120. The spacers 114 prevent crosstalk between the adjacent discharge cells. The spacers 114 can be formed of a dielectric material, such as glass. A dielectric layer (not shown) for reflecting visible light generated from the discharge cells toward the upper substrate 120 can further be formed on the lower substrate 110.

Referring to FIG. 4C, a first sealing paste 141 may be coated on an upper rim portion of the lower substrate 110. The first sealing paste 141 is preferably a plastic based frit paste so as to be fired at temperature of approximately about 450 to about 490° C.

Referring to FIG. 4D, frames 116 may be attached to the upper surface of the lower substrate 110 on which the first sealing paste 141 is coated. The frames 116 can be formed to one body. The purpose of the frames 116 may be to maintain a uniform gap between the lower substrate 110 and the upper substrate 120 and to seal the discharge space.

Referring to FIG. 4E, a phosphor may be coated on inner walls of the discharge space formed by the frames 116 on the lower substrate 110. That is, the phosphor may be coated on an upper surface of the lower substrate 110, surfaces of the spacers 114, and on inner walls of the frames 116. Then, the phosphor and the first sealing paste 141 are fired at a predetermined temperature simultaneously. The phosphor and the first sealing paste 141 can be fired at temperature of approximately about 450 to about 490° C., and preferably, at about 480° C. Through the firing process, the frames 116 may be fixed on the lower substrate 110 and the phosphor layer 130 may be formed on an upper surface of the lower substrate 110, side surfaces of the spacers 114, and on inner walls of the frames 116. This completes the manufacturing of a lower panel 170.

Referring to FIG. 4F, the manufacturing of a flat lamp may be completed by coupling the upper panel 180 and the lower panel 170. More specifically, a second sealing paste 142 may be coated on an upper surface of the frames 116 fixed on the lower substrate 110. The second sealing paste 142 may be preferably a terpineol based frit paste so as to be fired at temperature of approximately about 420 to about 450° C. Next, after coupling the upper panel 180 on an upper surface of the frames 116 on which the second sealing paste 142 is coated, the second sealing paste 142 can be fired at temperature of approximately about 420 to about 450° C., preferably, at about 440° C. If the aforementioned plastic based frit paste is used as the second sealing paste 142, the plastic based frit paste negatively affects to the phosphor in the process for heating the phosphor at temperature of about 450 to about 490° C. Also, there may be a problem of remaining binders, which are existed in the frit paste and the phosphor, in the discharge space.

In the present embodiment, a case in which the discharge electrodes may be formed on both the upper panel and the lower panel has been described, but the present invention is not limited thereto, and the discharge electrode can be formed on one of the lower panel and the upper panel. Also, the method of manufacturing a flat lamp according to the present invention can not only be applied to the aforementioned surface discharge type flat lamp but also be applied to the facing discharge type flat lamp.

As described above, according to the method of manufacturing a flat lamp according to the present invention, a phosphor and a sealing paste can be fired simultaneously by using a high temperature frit paste for fixing frames on the lower substrate. Accordingly, in the present invention, the flat lamp can be manufactured in a simple process since a process for firing the sealing paste or a process for coating phosphor on a surface of the frames and firing the phosphor is not additionally required.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a flat lamp comprising:
attaching at least a spacer on a lower substrate;
coating a first sealing paste on an upper rim portion of the lower substrate and attaching a frame for sealing a discharge space on the first sealing paste;
coating a phosphor on an upper surface of the lower substrate, surfaces of the spacers, and an inner wall of the frame; and
firing the first sealing paste and the phosphor at a predetermined temperature.

2. The method of claim 1, wherein the first sealing paste and the phosphor are fired at a temperature of about 450 to about 490° C.

3. The method of claim 2, wherein the first sealing paste and the phosphor are fired at a temperature of about 480° C.

4. The method of claim 2, wherein the first sealing paste is a frit paste.

5. The method of claim 4, wherein the frit paste is a plastic based paste.

6. The method of claim 1, wherein the attaching the spacers includes forming a dielectric layer on an upper surface of the lower substrate and attaching the spacers on the dielectric layer.

7. The method of claim 1, further comprising forming at least a lower electrode on the lower substrate.

8. The method of claim 7, wherein the lower electrodes are formed on a lower surface of the lower substrate before attaching the spacers on the lower substrate.

9. The method of claim 8, wherein the lower electrodes are formed by forming an electrode material in a predetermined shape on a lower surface of the lower substrate and firing the electrode material at a temperature of about 530 to about 590° C.

10. The method of claim 1, further comprising:
forming a phosphor layer on a lower surface of the upper substrate; and
coupling the upper substrate on which the phosphor layer is formed to an upper surface of the frames.

11. The method of claim 10, wherein the coupling the upper substrate includes:
coating a second sealing paste on an upper surface of the frame and attaching the upper substrate on which the phosphor layer is formed on the second sealing paste; and
firing the second sealing paste at a predetermined temperature.

12. The method of claim 11, wherein the second sealing paste is fired at a temperature of about 420 to about 450° C.

13. The method of claim 12, wherein the second sealing paste is fired at a temperature of about 440° C.

14. The method of claim 12, wherein the second sealing paste is frit paste.

15. The method of claim 14, wherein the frit paste is a terpineol based paste

16. The method of claim 10, wherein the phosphor layer is formed by coating a phosphor on a lower surface of the upper substrate and firing the phosphor at a predetermined temperature.

17. The method of claim 16, wherein the phosphor is fired at a temperature of about 450 to about 490° C.

18. The method of claim 17, wherein the phosphor is fired at a temperature of about 480° C.

19. The method of claim 10, further comprising forming at least one upper electrode on the upper substrate.

20. The method of claim 19, wherein the upper electrodes are formed on an upper surface of the upper substrate before forming the phosphor layer on a lower surface of the upper substrate.

21. The method of claim 20, wherein the upper electrodes are formed by forming an electrode material in a predetermined shape on a lower surface of the upper substrate and firing the electrode material at a temperature of about 530 to about 590° C.
